(19) United States
(12) Patent Application Publication
(10) Pub. No.: US 2008/0238846 A1
(43) Pub. Date: Oct. 2, 2008

(54) Liquid crystal display and driving method thereof

(75) Inventor: Berkeley Brian, Seongnam-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 12/079,499

(22) Filed: Mar. 26, 2008

(30) Foreign Application Priority Data
Mar. 30, 2007 (KR) 10-2007-0031349

(51) Int. Cl. G09G 3/36

(52) U.S. Cl. 345/87

(57) ABSTRACT

A liquid crystal display includes a plurality of pixels arranged in a matrix, data lines and gate lines that are connected to the pixels, a signal controller that processes image data from an external device and outputs normal image data and impulsive image data, a gray voltage generator that generates a plurality of gray voltages, and a data driver that selects data voltages and an impulsive voltage corresponding to the normal image data and the impulsive image data among the gray voltages, respectively, and applies them to the data lines. The impulsive voltage is applied by an impulsive voltage application unit having a plurality of pixel rows at one time, one frame has a plurality of impulsive voltage application groups, each to which the impulsive voltage is applied by the impulsive voltage application unit, and positions of first rows of the respective impulsive voltage application groups of two adjacent frames in a unit frame group have a difference of a predetermined number.

### CROSS-REFERENCE TO RELATED APPLICATION

This application claims priority to and the benefit of Korean Patent Application No. 10-2007-0031349 filed in the Korean Intellectual Property Office on Mar. 30, 2007, the entire contents of which are incorporated herein by reference.

### BACKGROUND OF THE INVENTION

(a) Field of the Invention

The present invention relates to a liquid crystal display and a driving method thereof.

(b) Description of the Related Art

In general, a liquid crystal display includes two display panels, one having pixel electrodes and the other a common electrode. A liquid crystal layer having dielectric anisotropy interposed therebetween. The pixel electrodes are arranged in a matrix and connected to switching devices such as thin film transistors (TFTs) so as to be sequentially applied with data voltages in units of a pixel row. The common electrode is disposed over the entire surface of one display panel and is supplied with a common voltage. In terms of a circuit, the pixel electrode, the common electrode, and the liquid crystal layer interposed therebetween constitute a liquid crystal capacitor. The liquid crystal capacitor together with the switching element connected thereto is referred to as a pixel unit.

In the LCD, voltages are applied to the two electrodes to generate an electric field in the liquid crystal layer, and the strength of the electric field is controlled to control transmittance of light that passes through the liquid crystal layer, thus obtaining desired images. In this case, in order to prevent degradation generated as the electric field is applied for a long time in one direction to the liquid crystal layer, polarity of the data voltages with respect to the common voltage is inverted by frames, by rows, or by pixels.

Since the LCD is a display device of a hold type, a blurring phenomenon in which edges of the displayed images are not clear and blurring occurs when displaying moving images. To decrease the blurring phenomenon, an impulsive driving manner has been developed, to display a black image between desired normal images.

Black image data for generating the black image is called an impulsive voltage and normal image data for the normal image is called data voltage. The black image data and the normal image data are applied to the data lines.

The impulsive voltage is applied by a pixel row unit of a predetermined number of rows at one time. Data voltage maintaining times and impulsive voltage maintaining times in the last row of a previous pixel row unit and the first row of the next pixel row unit are different, and thereby a horizontal line error occurs.

### SUMMARY OF THE INVENTION

According to an embodiment of the present invention, a liquid crystal display is provided, which includes a plurality of pixels that are arranged in a matrix, data lines and gate lines that are connected to the pixels, a signal controller that processes image data from an external device and outputs normal image data and impulsive image data, a gray voltage generator that generates a plurality of gray voltages, and a data driver that selects data voltages and an impulsive voltage corresponding to the normal image data and the impulsive image data among the gray voltages, respectively, and applies them to the data lines. The impulsive voltage is applied by an impulsive voltage application unit having a plurality of pixel rows at one time, one frame has a plurality of impulsive voltage application groups, each of which has the impulsive voltage applied thereto by the impulsive voltage application unit, and positions of first rows of the respective impulsive voltage application groups of two adjacent frames in a unit frame group are different by a predetermined number.

The impulsive voltage application unit may have a number N of rows that is a multiple of “2”.

The unit frame group may include two successive frames, and positions of the first rows of the corresponding impulsive voltage application groups of two adjacent frames of the unit frame group may have a difference of N/2.

The signal controller may output about 120 frames per second to the data driver.

A maintaining time of the data voltage and a maintaining time of the impulsive voltage between the adjacent pixel rows may have a difference of about 1H, respectively.

The liquid crystal display may further a gate driver that applies a gate-on voltage to the gate lines, and the gate driver may apply the gate-on voltage twice to the gate lines in one frame.

The impulsive voltage application unit may have a number of rows that is a multiple of “3”.

The unit frame group may include two successive frames, and positions of the first rows of the corresponding impulsive voltage application groups of two adjacent frames of the unit frame group may have a difference of N/2.

The signal controller may output about 120 frames per second to the data driver, and a maintaining time of the data voltage and a maintaining time of the impulsive voltage between the adjacent pixel rows may have a difference of about 1H, respectively.

According to another embodiment, a driving method of a liquid crystal display including a plurality of pixels arranged in a matrix and a plurality of gate lines and a plurality of data lines that are connected to the pixels is provided, which includes transmitting normal image data and impulsive image data by processing image data from an external device, generating a plurality of gray voltages, applying a gate-on voltage twice to the gate lines, selecting data voltages and an impulsive voltage corresponding to the normal image data and the impulsive image data among the gray voltages, respectively and applying to the data lines, and applying the impulsive voltage by an impulsive voltage application unit having a plurality of pixel rows at one time, wherein one frame has a plurality of impulsive voltage application groups, each of which has the impulsive voltage applied thereto by the impulsive voltage application unit, and positions of first rows of the respective impulsive voltage application groups of two adjacent frames in a unit frame group have a difference of a predetermined number.

The impulsive voltage application unit may have a number N of rows that is a multiple of “2”.

The unit frame group may include two successive frames, and positions of the first rows of the corresponding impulsive voltage application groups of two adjacent frames of the unit frame group may have a difference of N/2.

The transmission of the normal image data and the impulsive image data may include outputting about 120 frames per second.

A maintaining time of the data voltage and a maintaining time of the impulsive voltage between the adjacent pixel rows may have a difference of about 1H, respectively.

The impulsive voltage application unit may have a number of rows that is a multiple of “3”.

The unit frame group may include three successive frames, and positions of the first rows of the corresponding impulsive voltage application groups of two adjacent frames of the unit frame group may have a difference of N/3.

The transmission of the normal image data and the impulsive image data may include outputting about 180 frames per second, and at this time, a maintaining time of the data voltage and a maintaining time of the impulsive voltage between the adjacent pixel rows may have a difference of about 1H, respectively.

According to further another embodiment, a liquid crystal display is provided, which includes a plurality of pixels arranged in a matrix, data lines and gate lines coupled to the pixels, a signal controller adapted to process received image data and generate normal image data and impulsive image data, a gate driver adapted to apply a gate on voltage to the gate lines, a gray voltage generator operative to generate a plurality of gray voltages, and a data driver coupled to the gray voltage generator, the data driver being operative to select data voltages and an impulsive voltage corresponding to the normal image data and the impulsive image data from among the gray voltages, respectively, and apply the data voltages and impulsive voltage to the data lines. The data driver is operative to apply impulsive voltage simultaneously to impulsive voltage application units each comprising a plurality of pixel rows. The application is such that within one frame an impulsive voltage is applied to a plurality of impulsive voltage applications units, and gate on voltage application orders corresponding the data voltages in the impulsive voltage application units corresponding to each other in two adjacent frames of a unit frame group are opposite, respectively.

The data voltages in the impulsive voltage application units may be applied in a reverse order in accordance with the gate on voltage application order.

The signal controller may include a frame memory, and may generate the normal image data in the reverse order in the impulsive voltage application units to apply the data voltages in the reverse order.

The gate driver may apply the gate on voltage twice to one gate line in a frame.

According to more further embodiment, a driving method of a liquid crystal display comprising a plurality of pixels arranged in a matrix and a plurality of gate lines and a plurality of data lines that are connected to the pixels is provided, which includes transmitting normal image data and impulsive image data by processing image data from an external device, generating a plurality of gray voltages, applying a gate on voltage twice to the gate lines, selecting data voltages and an impulsive voltage corresponding to the normal image data and the impulsive image data among the gray voltages, respectively and applying to the data lines, and applying the impulsive voltage simultaneously to impulse voltage application units each unit comprising a plurality of pixel rows. Each frame has a plurality of impulsive application units, each to which the impulsive voltage is applied, and gate on voltage application orders corresponding the data voltages in the impulsive voltage application units corresponding to each other in two adjacent frames of a unit frame group are opposite, respectively.

The selection of the data voltages and the impulsive voltage may include applying the data voltages in the impulsive voltage application units in a reverse order in accordance with the gate on voltage application order when the gate on voltage is applied in the reverse order.

### BRIEF DESCRIPTION OF THE DRAWINGS

An exemplary embodiment of the present invention is described below in detail with reference to the accompanying drawings, wherein:

FIG. 1 is a block diagram of an LCD according to an exemplary embodiment of the present invention;

FIG. 2 is an equivalent circuit diagram of a pixel of the LCD shown in FIG. 1;

FIG. 3 is a timing diagram showing positions at which an impulsive voltage is applied in odd-numbered frames of an LCD according to an exemplary embodiment of the present invention;

FIG. 4 is a timing diagram showing positions at which an impulsive voltage is applied in even-numbered frames of an LCD according to an exemplary embodiment of the present invention;

FIG. 5 is a table illustrating data voltage maintaining times and impulsive voltage maintaining times of an LCD according to an exemplary embodiment of the present invention;

FIG. 6 is a table illustrating data voltage maintaining times and impulsive voltage maintaining times of a prior art LCD;

FIG. 7 is a timing diagram showing positions at which an impulsive voltage is applied in odd-numbered frames of an LCD according to another exemplary embodiment of the present invention;

FIG. 8 is a timing diagram showing positions at which an impulsive voltage is applied in even-numbered frames of an LCD according to another exemplary embodiment of the present invention, and

FIG. 9 is a table representing data voltage maintaining times and impulsive voltage maintaining times of an LCD according to another exemplary embodiment of the present invention.

### DETAILED DESCRIPTION OF THE EMBODIMENTS

The present invention is described more fully hereinafter with reference to the accompanying drawings, in which exemplary embodiments of the present invention are shown. This invention may, however, be embodied in many different forms and should not be construed as limited to the exemplary embodiments set forth herein. In the drawings, the thickness of layers and regions are exaggerated for clarity. Like numerals refer to like elements throughout. It will be understood that when an element such as a layer, film, region, substrate, or panel is referred to as being “on” another element, it can be directly on the other element or intervening elements may also be present. In contrast, when an element is referred to as being “directly on” another element, there are no intervening elements present. As used herein, the term “and/or” includes any and all combinations of one or more of the associated listed items. It will be understood that, although the terms first, second, third, etc., may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present invention. The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification specify the presence of stated features, regions, integers, steps, operations, elements, and/or components, but do not preclude the presence or addition of one or more other features, regions, integers, steps, operations, elements, components, and/or groups thereof. Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein may be interpreted accordingly. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. Embodiments of the present invention are described herein with reference to cross-section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. As an example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

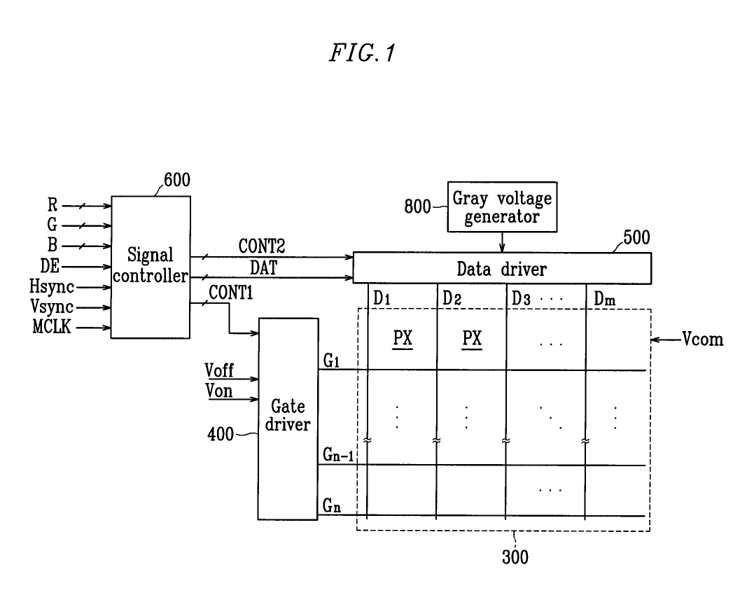

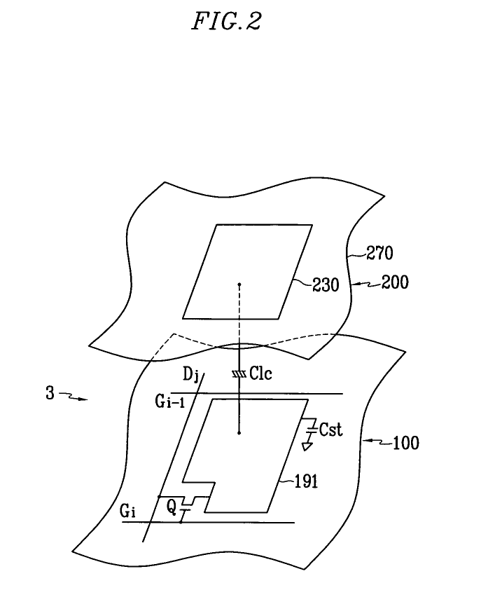

An LCD and a driving method thereof according to an exemplary embodiment of the present invention is described below in detail with reference to FIGS. 1 and 2.

FIG. 1 is a block diagram of an LCD according to an exemplary embodiment of the present invention, and FIG. 2 is an equivalent circuit diagram of a pixel of the LCD shown in FIG. 1.

Referring to FIG. 1, an LCD according to an embodiment includes a liquid crystal (LC) panel assembly 300, a gate driver 400 and a data driver 500 that are coupled with the panel assembly 300, a gray voltage generator 800 coupled with the data driver 500, and a signal controller 600 controlling the above elements.

The panel assembly 300 includes a plurality of signal lines G₁-Gₙ and D₁-Dₘ and a plurality of pixels PX which are arranged in a matrix and which are connected to the signal lines G₁-Gₙ and D₁-Dₘ. In the structural view shown in FIG. 2, the panel assembly 300 includes lower and upper panels 100 and 200 facing each other and an LC layer 3 interposed between the panels 100 and 200.

The signal lines include a plurality of gate lines G₁-Gₙ transmitting gate signals (also referred to as “scanning signals” hereinafter) and a plurality of data lines D₁-Dₘ transmitting data voltages. The gate lines G₁-Gₙ extend substantially in a row direction and are substantially parallel to each other, while the data lines D₁-Dₘ extend substantially in a column direction and are substantially parallel to each other.

Referring to FIG. 2, each pixel PX, for example a pixel PX connected to the i-th gate line Gᵢ (i=1, 2, . . . , n) and the j-th data line Dⱼ (j=1, 2, . . . , m), includes a switching element Q connected to the signal lines Gᵢ and Dⱼ, and an LC capacitor Clc and a storage capacitor Cst that are connected to the switching element Q. The storage capacitor Cst is optional.

The switching element Q is disposed on the lower panel 100 and has three terminals, i.e., a control terminal connected to the gate line Gᵢ, an input terminal connected to the data line Dⱼ, and an output terminal connected to the LC capacitor Clc and the storage capacitor Cst.

The LC capacitor Clc includes a pixel electrode 191 disposed on the lower panel 100 and a common electrode 270 disposed on the upper panel 200 as two terminals. The LC layer 3 disposed between the two electrodes 191 and 270 functions as a dielectric of the LC capacitor Clc. The pixel electrode 191 is connected to the switching element Q, and the common electrode 270 is supplied with a common voltage Vcom and covers an entire surface of the upper panel 200. Unlike in FIG. 2, the common electrode 270 may be provided on the lower panel 100, and at least one of the electrodes 191 and 270 may have a shape of a bar or a stripe.

The storage capacitor Cst is an auxiliary capacitor for the LC capacitor Clc. The storage capacitor Cst includes the pixel electrode 191 and a separate signal line, which is provided on the lower panel 100, overlaps the pixel electrode 191 via an insulator, and is supplied with a predetermined voltage such as the common voltage Vcom. Alternatively, the storage capacitor Cst includes the pixel electrode 191 and an adjacent gate line called a previous gate line, which overlaps the pixel electrode 191 via an insulator.

For color display, each pixel uniquely represents one of primary colors (i.e., spatial division) or each pixel sequentially represents the primary colors in turn (i.e., temporal division) such that a spatial or temporal sum of the primary colors is recognized as a desired color. An example of a set of primary colors includes red, green, and blue. FIG. 2 shows an example of the spatial division in which each pixel includes a color filter 230 representing one of the primary colors in an area of the upper panel 200 facing the pixel electrode 191. Alternatively, the color filter 230 is provided on or under the pixel electrode 191 on the lower panel 100.

One or more polarizers (not shown) are attached to the panel assembly 300.

Referring to FIG. 1 again, the gray voltage generator 800 generates a full number of gray voltages or a limited number of gray voltages (referred to as “reference gray voltages” hereinafter) related to the transmittance of the pixels PX. Some of the (reference) gray voltages have a positive polarity relative to the common voltage Vcom, while the other of the (reference) gray voltages have a negative polarity relative to the common voltage Vcom.

The gate driver 400 is connected to the gate lines G₁-Gₙ of the panel assembly 300, and synthesizes a gate-on voltage Von and a gate-off voltage Voff to generate the gate signals for application to the gate lines G₁-Gₙ at least twice.

The data driver 500 is connected to the data lines D₁-Dₘ of the panel assembly 300 and applies data voltages, which are selected from the gray voltages supplied from the gray voltage generator 800, to the data lines D₁-Dₘ. However, when the gray voltage generator 800 generates only a few of the reference gray voltages rather than all the gray voltages, the data driver 500 may divide the reference gray voltages and generate all the gray voltages and select the data voltages from among the gray voltages.

The signal controller 600 controls the gate driver 400, the data driver 500, and the gray voltage generator 800.

Each of driving devices 400, 500, 600, and 800 may include at least one integrated circuit (IC) chip mounted on the LC panel assembly 300 or on a flexible printed circuit (FPC) film in a tape carrier package (TCP) type, which are attached to the panel assembly 300. Alternatively, at least one of the driving devices 400, 500, 600, and 800 may be integrated into the panel assembly 300 along with the signal lines G₁-Gₙ and D₁-Dₘ and the switching elements Q. As a further alternative, all the driving devices 400, 500, 600, and 800 may be integrated into a single IC chip, but at least one of the driving devices 400, 500, 600, and 800 or at least one circuit element in at least one of the driving devices 400, 500, 600, and 800 may be disposed out of the single IC chip.

The operation of the above-described LCD is described below in detail.

The signal controller 600 is supplied with input image signals R, G, and B and input control signals for controlling the display thereof from an external graphics controller (not shown). The input image signals R, G, and B contain luminance information of pixels PX, and the luminance has a predetermined number of grays, for example 1024 (=2¹⁰), 256 (=2⁸), or 64 (=2⁶) grays. The input control signals include a vertical synchronization signal Vsync, a horizontal synchronization signal Hsync, a main clock signal MCLK, and a data enable signal DE.

On the basis of the input control signals and the input image signals R, G, and B, the signal controller 600 generates gate control signals CONT1 and data control signals CONT2 and processes the image signals R, G, and B to be suitable for the operation of the panel assembly 300 and the data driver 500. The signal controller 600 sends the gate control signals CONT1 to the gate driver 400 and sends the processed image signals DAT and the data control signals CONT2 to the data driver 500. The output signals DAT are digital signals and have a predetermined value (or gray).

The gate control signals CONT1 include a scanning start signal STV for instructing to start scanning and at least one clock signal for controlling the output period of the gate-on voltage Von. The gate control signals CONT1 may include an output enable signal OE for defining the duration of the gate-on voltage Von.

The data control signals CONT2 include a horizontal synchronization start signal STH for informing of start of data transmission for a row of pixels PX, a load signal TP for instructing to apply the data voltages to the data lines D₁-Dₘ of the LC panel assembly 300, and a data clock signal HCLK. The data control signal CONT2 may further include a polarity signal POL for reversing the polarity of the data voltages (relative to the common voltage Vcom).

Responsive to the data control signals CONT2 from the signal controller 600, the data driver 500 receives a packet of the digital image signals DAT for the row of pixels PX from the signal controller 600, converts the digital image signals DAT into analog data voltages selected from the gray voltages, and applies the analog data voltages to the data lines D₁-Dₘ.

The gate driver 400 applies the gate-on voltage Von to a gate line G₁-Gₙ in response to the gate control signals CONT1 from the signal controller 600, thereby turning on the switching transistors Q connected thereto. The data voltages applied to the data lines D₁-Dₘ are then supplied to the pixels PX through the activated switching transistors Q.

A difference between a data voltage and the common voltage Vcom applied to a pixel PX is represented as a voltage across the LC capacitor Clc of the pixel PX, which is referred to as a pixel voltage. The LC molecules in the LC capacitor Clc have orientations depending on the magnitude of the pixel voltage, and the molecular orientations determine the polarization of light passing through the LC layer 3. The polarizer(s) converts light polarization to light transmittance such that the pixel PX has a luminance represented by a gray of the data voltage.

By repeating this procedure by a unit of a horizontal period (which is also referred to as “1H” and is equal to one period of the horizontal synchronization signal Hsync and the data enable signal DE), all gate lines G₁-Gₙ are sequentially supplied with the gate-on voltage Von, thereby applying the data voltages to all pixels PX to display an image for a frame.

When the next frame starts after one frame finishes, the polarity signal POL applied to the data driver 500 is controlled such that the polarity of the data voltages is reversed (which is referred to as “frame inversion”). The polarity signal POL may also be controlled such that the polarity of the data voltages flowing in a data line are periodically reversed during one frame (for example row inversion and dot inversion), or the polarity of the data voltages in one packet are reversed (for example column inversion and dot inversion).

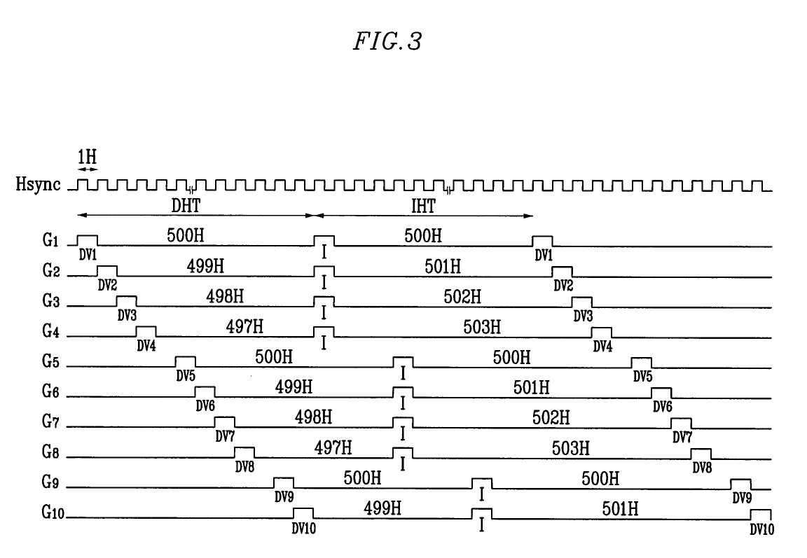

Referring to FIGS. 3 to 6, the operation of the LCD according to an exemplary embodiment of the present invention is described below in more detail.

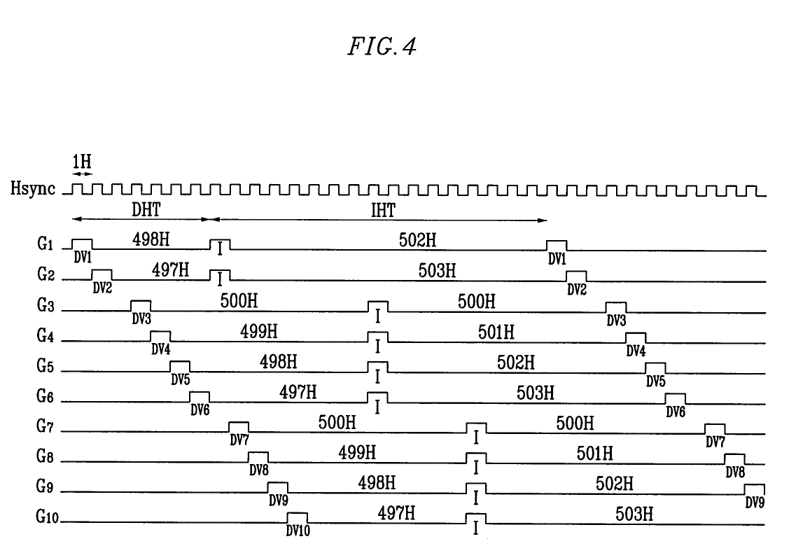

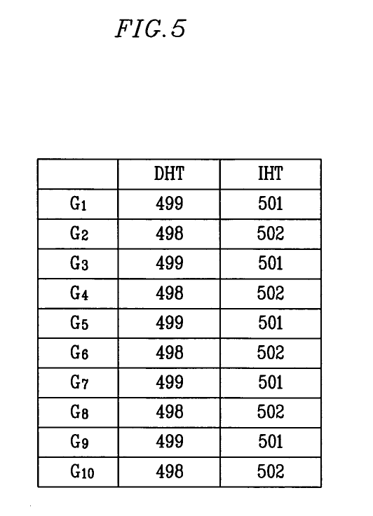

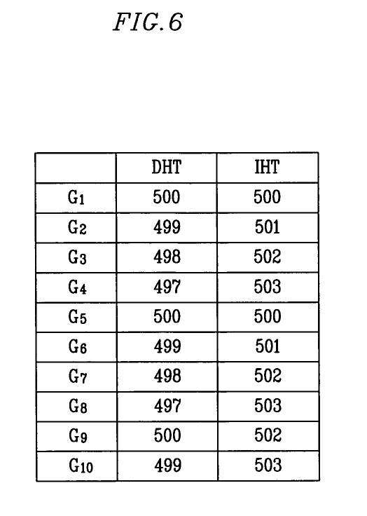

FIGS. 3 and 4 are timing diagrams showing positions at which an impulsive voltage is applied in odd-numbered frames and in even-numbered frames, respectively, of an LCD according to an exemplary embodiment of the present invention. FIG. 5 is a table illustrating data voltage maintaining times and impulsive voltage maintaining times of an LCD according to an exemplary embodiment of the present invention; and FIG. 6 is a table illustrating data voltage maintaining times and impulsive voltage maintaining times of an LCD according to a prior art.

An LCD according to an exemplary embodiment of the present invention uses about 120 frames or about 180 frames per second to display images. That is, the LCD operates based on an operation frequency of about 120 Hz or about 180 Hz. For an operation frequency of the LCD of about 120 Hz, FIG. 3 is a timing diagram showing application time of an impulsive voltage I and data voltages in odd-numbered frames, and FIG. 4 is a timing diagram showing application time of the impulsive voltage I and the data voltages in even-numbered frames.

In FIGS. 3 and 4, first to tenth gate lines G₁-G₁₀ of all the gate lines G₁-Gₙ (n=1000) are shown, and a gate on voltage Von is applied at high level portions and a gate off voltage Voff is applied at low level portions. That is, the gate driver 400 applies the gate on voltage Von twice in one frame to the gate lines G₁-Gₙ; and the data driver 500 outputs the data voltages and the impulsive voltage I to the data lines D₁-Dₘ based on the gate on voltage Von.

At this time, as described above, one period of the horizontal synchronization signal Hsync is about 1H, and the gate-on voltage Von is output in synchronization with the horizontal synchronization signal Hsync.

In addition, an example of the total number of gate lines G₁-Gₙ is defined as about 1000.

In this embodiment, the impulsive voltage I is simultaneously applied to four rows, and hereinafter the four rows are referred to as an impulsive voltage application unit. Although in this example the impulsive voltage is applied to four rows, it may be applied to other numbers of rows. In one frame, a plurality of impulse voltage application units receive an impulsive voltage. The plurality of units are hereinafter referred to as impulsive voltage application groups. In this embodiment, since the number of the gate lines G₁-Gₙ is 1000, and each impulse voltage application unit includes four gate lines, the total number of impulsive voltage application groups in one frame is 250.

After the data voltage DV1-DV10 is applied, a time until the impulsive voltage I is applied is called a data voltage maintaining time DHT, and after the impulsive voltage I is applied, a time until the data voltage DV1-DV10 is applied is called an impulsive voltage maintaining time IHT.

In the LCD according to this embodiment, in a first row of a first impulsive voltage application group, percentages of the maintaining times DHT and IHT of the data voltage and the impulsive voltage are about 50%, respectively, but this may be changed. In this embodiment, the impulsive voltage may be a data voltage for displaying a black image.

Referring to FIG. 3, after the gate on voltage Von is sequentially applied to the first to fourth pixel rows at about 1H intervals such that the data voltages DV1-DV4 are applied to the first to fourth pixel rows, the impulsive voltage I is simultaneously applied to four pixel rows that are the first to fourth pixel rows after about 500H including the application time of the data voltage DV1 with respect to the first pixel row.

Then, the maintaining times DHT of the data voltages DV2-DV4 with respect to the second to fourth pixel rows are about 499H, about 498H, and about 497H, respectively.

The impulsive voltage I is maintained until the data voltages are applied in the next frame, and the sum of the data voltage maintaining time DHT and the impulsive voltage maintaining time IHT is about 1000H. Thus, the impulsive voltage I applied to the first to fourth pixel rows is maintained for about 500H, about 501H, about 502H, and about 503H, respectively.

As described above, since the impulsive voltage I is applied 250 times every impulsive voltage application group for one frame, a time of about 250H is required for applying the impulsive voltage for one frame.

Since the data voltages and the impulsive voltage I are not simultaneously applied, 1000H for applying the data voltage to the pixel rows of 1000 and 250H for applying the impulsive voltage I for the impulsive voltage application groups of 250 are required. Accordingly, for one frame, a required time for applying the data voltages and the impulsive voltage I is about 1250H. In a case that the percentages of the maintaining times of the data voltages and the impulsive voltage are about 50%, respectively, the data voltage maintaining time DHT and the impulsive voltage maintaining time IHT with respect to one pixel row are about 625H which is the sum of 500H (=1000H/2) and 125H (=250H/2), respectively. However, in FIGS. 3 and 4, for convenience of explanation, the data voltage maintaining time DHT and the impulsive data maintaining time IHT are represented based on an application time of the data voltage except for an application time of the impulsive voltage I.

Referring to FIG. 4, as in FIG. 3, four rows function as an impulsive voltage application unit, and thereby the impulsive voltage I is simultaneously applied to four rows, and 250 impulsive voltage application groups exist. However, compared with FIG. 3 and 4, positions of the pixel rows at which the impulsive voltage I is applied, that is, start positions of the impulsive voltage application groups, are different. That is, as shown in FIG. 3, in the odd-numbered frames, a first row of the first impulsive voltage application group is a first pixel row. However, as shown in FIG. 4, in the even-numbered frames, the first row of the first group is a third pixel row.

The position of the first row of the respective impulsive voltage application group in the odd-numbered and even-numbered frames is represented by [Equation 1] and [Equation 2] as below, respectively.

K1=4×M−3 [Equation 1]

K2=4×M−1 [Equation 2]

where K1 and K2 are the numbers of pixel rows of the first rows of the respective impulsive voltage application groups in the odd-numbered and even-numbered frames, and M is a natural number and represents the number of the respective impulsive voltage application group.

Averages of the data voltage maintaining time DHT and the impulsive voltage maintaining time IHT in two adjacent frames are shown in FIG. 5.

As an example, referring to FIGS. 3 and 4, in the first pixel row, the data voltage maintaining times DHT are about 500H and about 498H, respectively, and the impulsive voltage maintaining times IHT are about 500H and about 502H, respectively. Thus, as shown in FIG. 5, the averages of the data voltage maintaining times DHT and the impulsive voltage maintaining times IHT are about 499H and about 501H, respectively.

In the second pixel row, the data voltage maintaining times DHT are about 499H and about 497H, respectively, and the impulsive voltage maintaining times IHT are about 501H and about 503H, respectively, and thereby the averages of the data voltage maintaining times DHT and the impulsive voltage maintaining times IHT are about 498H and about 502H, respectively, as shown in FIG. 5.

Compared with the data voltage maintaining times DHT and the impulsive voltage maintaining times IHT with respect to all the pixel rows, differences of the maintaining times DHT and IHT between two adjacent pixel rows are about 1H which is the minimum, respectively, and are uniform. Thereby, since variations of the data voltage maintaining time DHT and the impulsive voltage maintaining time IHT are constant, a horizontal line error due to an irregular variation amount of the maintaining times DHT and IHT is prevented.

That is, in FIG. 6, the differences of the maintaining times DHT and IHT between a fourth pixel row and a fifth pixel row are about 3H, respectively, and an image of the fourth pixel row is darker than that of the fifth pixel row due to the impulsive voltage maintaining time IHT that is longer than the data voltage maintaining time DHT to cause the horizontal line error. The table shown in FIG. 6 represents average times of the data voltage maintaining time DHT and the impulsive voltage maintaining time IHT between two adjacent frames in an LCD according to a prior art in which the data voltages and the impulsive voltage are applied based on the timing diagram shown in FIG. 3 every frame. That is, the impulsive voltage is applied to the same pixel rows every frame, and thereby the horizontal line error occurs due to the irregular variation amount of the maintaining times DHT and IHT.

However, in this embodiment, the application positions of the impulsive voltage I is changed every frame such that the maintaining times DHT and IHT of all the pixel rows have a constant difference of about 1H to prevent the horizontal line error.

Since the LCD of the embodiment operates based on the operation frequency of about 120 Hz which is twice about 60 Hz, and the application positions of the impulsive voltage are repeated by a unit frame group having two frames of an odd-numbered frame and an even-numbered frame, the averages of the maintaining times DHT and IHT are the averages of two frames that form the unit frame group. Accordingly, K1 and K2 of [Equation 1] and [Equation 2] are more normalized.

That is, a difference of K1 and K2 of [Equation 1] and [Equation 2] is 2 as in [Equation 3].

K2−K1=2 [Equation 3]

As described above, in two adjacent frames that form the unit frame, the difference “2” of the number of pixel rows of the first rows of the corresponding impulsive voltage application groups is obtained by division by the number “2” of frames of the unit frame group. In addition, when the number of rows of the impulsive voltage application unit is 6, the difference of the number of pixel rows of the first rows of the corresponding impulsive voltage application groups is “3”.

When the number of frames of the unit frame group is multiplied by the differences “2” and “3” of the number of pixel rows of the first rows of the corresponding impulsive voltage application groups, the number of rows of the impulsive voltage application unit is obtained. In other words, for obtaining the difference of the number of pixel rows of the first rows of the corresponding impulsive voltage application groups in the unit frame group, the number of the impulsive voltage application units must be a multiple of “2”, which is presented as [Equation 4].

N=2×(K2−K1) [Equation 4]

where N is the number of rows of the impulsive voltage application unit, and (K2−K1) is a difference of application positions of the first rows of respective impulsive voltage application group in two adjacent frames of one unit frame group.

The law may be adapted in case that the operation frequency of the LCD is about 180 Hz, as in 120 Hz. That is, since in about 180 Hz that is three times of about 60 Hz, averages of the maintaining times DHT and IHT for three frames are required, and for calculating the averages of three frames, the number N of rows of the impulsive voltage application unit has to be a multiple number of “3”. In this case, the number of frames of the unit frame group is “3”. In addition, application positions between the first rows of the first impulsive voltage application groups of two adjacent frames in one unit frame group have a difference of N/3.

The above description with respect to the operation frequency of about 180 Hz is represented as [Equation 5].

N=3×(K2−K1) [Equation 5]

In summary, when the operation frequency of the LCD is about 120 Hz, the number N of rows of the impulsive voltage application unit is to be a multiple of “2”, and when the operation frequency of the LCD is about 180 Hz, the number N of rows of the impulsive voltage application unit is to be a multiple of “3”.

In addition, application positions between the first rows of the corresponding groups of two adjacent frames are equal to a value that is obtained by dividing the number N of rows of the impulsive voltage application unit by the number of frames of the unit frame group.

For example, when the number N of rows of the impulsive voltage application unit is 6, a difference of the first rows of the two first impulsive voltage application groups of one unit frame group is 3 in the operation frequency of about 120 Hz, and the difference is 2 in the operation frequency of about 180 Hz. That is, in the operation frequency of about 120 Hz, the first rows of the first to third impulsive voltage application groups are first, seventh, and thirteenth pixel rows, respectively in the first frame, and the first rows of the first to third impulsive voltage application groups are fourth, tenth, and sixteenth pixel rows, respectively, in the second frame. The application positions of the first rows are repeated by the unit frame group of two frames. In the operation frequency of about 180 Hz, the first frame is the same as that of about 120 Hz and thereby the first rows of the first to third impulsive voltage application groups are first, seventh, and thirteenth pixel rows, respectively, but in the second frame, the first rows of the first to third impulsive voltage application groups are third, ninth, and fifteenth pixel rows, respectively. In the third frame, the first rows of the first to third impulsive voltage application groups are third, ninth, and fifteenth pixel rows, respectively. The application positions of the first rows are repeated by the unit frame group of three frames.

This embodiment is described with respect to the operation frequencies of about 120 Hz and about 180 Hz based on the operation frequency of about 60 Hz, but may be adapted with respect to the operation frequency of about 60 Hz. In this case, the number of rows of the impulsive voltage application unit may be calculated by a unit frame of two frames on the basis of the operation frequency of about 30 Hz, or the number of rows of the impulsive voltage application unit may be calculated by a unit frame group of three frames on the basis of the operation frequency of about 20 Hz.

Accordingly, impulsive images based on the above techniques are displayed in the LCD of a hold type such that blurring is minimized. In addition, since the impulsive voltage application positions are varied every frame, the horizontal line error is prevented.

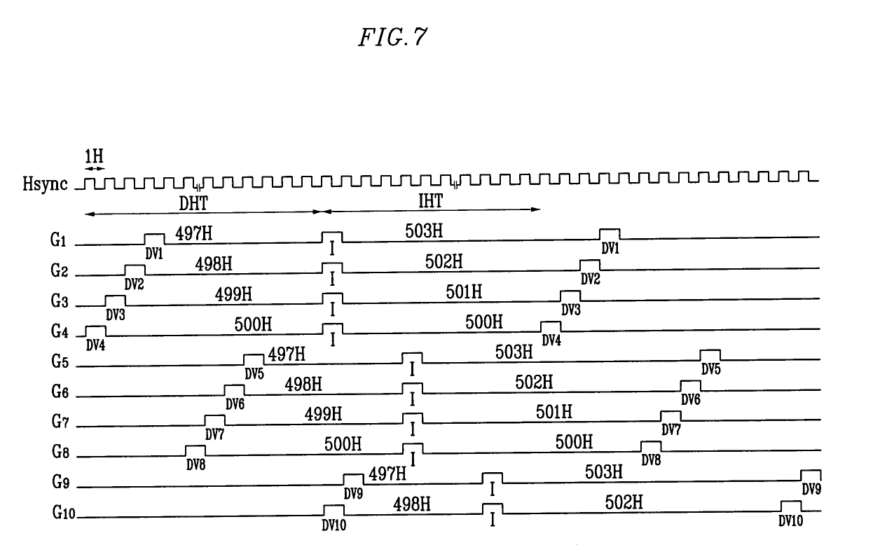

An LCD and a driving method thereof according to another exemplary embodiment of the present invention are described below in detail with reference to FIGS. 7 to 9.

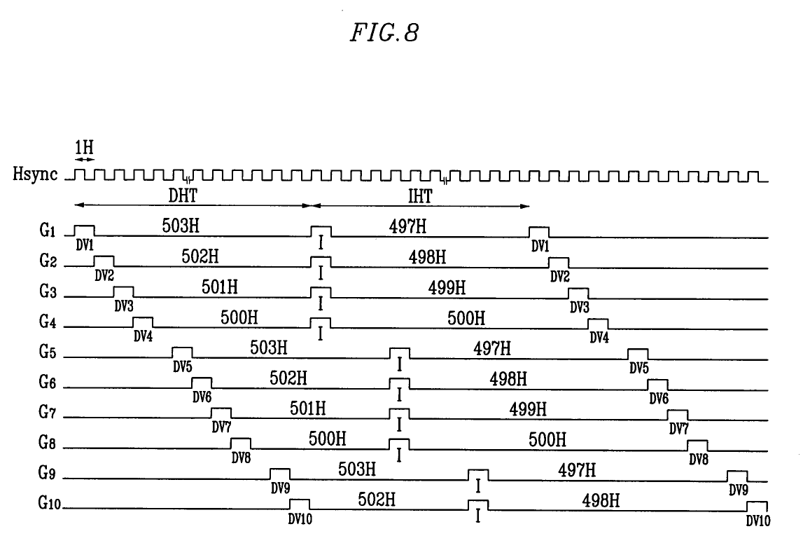

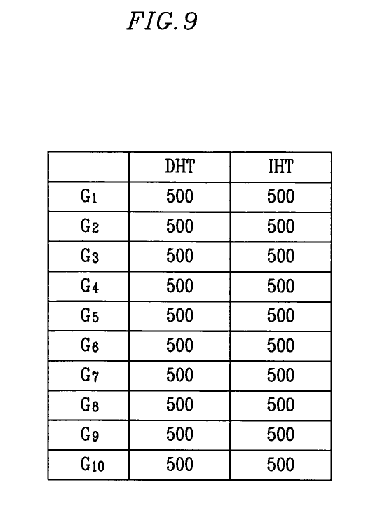

FIG. 7 is a timing diagram showing positions at which an impulsive voltage is applied in odd-numbered frames of an LCD according to another exemplary embodiment of the present invention, FIG. 8 is a timing diagram showing positions at which an impulsive voltage is applied in even-numbered frames of an LCD according to another exemplary embodiment of the present invention, and FIG. 9 is a table representing data voltage maintaining times and impulsive voltage maintaining times of an LCD according to another exemplary embodiment of the present invention.

An LCD according to another exemplary embodiment of the present invention uses about 120 frames or about 180 frames per second to display images. That is, the LCD operates based on an operation frequency of about 120 Hz or about 180 Hz. When theFor an operation frequency of the LCD is of about 120 Hz, FIG. 7 is a time diagram showing application time of an impulsive voltage I and data voltages in odd-numbered frames, and FIG. 8 is a time diagram showing application time of the impulsive voltage I and the data voltages in even-numbered frames.

In FIGS. 7 and 8, first to tenth gate lines G1-G10 of all the gate lines G1-Gn (n=1,000) are shown, and a gate on voltage Von is applied at high level portions and a gate off voltage Voff is applied at low level portions.

That is, the gate driver 400 applies the gate on voltage Von twice in one frame to the gate lines G1-Gn, and thereby the data driver 500 outputs the data voltages and the impulsive voltage I to the data lines D1-Dm based on the gate on voltage Von.

At this time, as described above, one period of the horizontal synchronization signal Hsync is about 1H, and the gate on voltage Von is output in synchronization with the horizontal synchronization signal Hsync.

In addition, an example of the total number of gate lines G1-Gn is defined as about 1,000.

Moreover, in this embodiment, the impulsive voltage I is simultaneously applied to four rows, and thereby the four rows become an impulsive voltage application unit, but it this is not defined fixed and may be changed. In one frame, a plurality of impulsive voltage application groups exist for applying the impulsive voltage to all the gate lines G1-Gn by the impulsive voltage application unit. In this embodiment, since the number of the gate lines G1-Gn is 1,000, the total number of impulsive voltage application groups is 250.

Hereinafter, after the data voltage DV1-DV10 is applied, a time until the impulsive voltage I is applied is called a data voltage maintaining time DHT, and after the impulsive voltage I is applied, a time until the data voltage DV1-DV10 is applied is called an impulsive voltage maintaining time IHT.

In the LCD according to this embodiment, in a first row of a first impulsive voltage application group, percentages of the maintaining times DHT and IHT of the data voltage and the impulsive voltage are about 50%, respectively, but it this may be changed. In this embodiment, the impulsive voltage may be a data voltage for displaying a black image.

Referring to FIG. 7, after the gate on voltage Von is sequentially applied to the fourth to first pixel rows at about 1H intervals such that the data voltages from DV4 to DV1 are applied to the fourth to first pixel rows in a reverse order, the impulsive voltage I is simultaneously applied to four pixel rows that are the fourth to first pixel rows after about 500H including the application time of the data voltage DV4 with respect to the fourth pixel row.

Then, the maintaining times DHT of the data voltages DV3-DV1 with respect to the third to first pixel rows are about 499H, about 498H, and about 497H, respectively.

The impulsive voltage I is maintained until the data voltages are applied in the next frame, and the sum of the data voltage maintaining time DHT and the impulsive voltage maintaining time IHT is about 1000H. Thus, the impulsive voltage I applied to the fourth to first pixel rows is maintained for about 500H, about 501H, about 502H, and about 503H, respectively.

Meanwhile, referring to FIG. 8, as in FIG. 7, four rows function as an impulsive voltage application unit, and thereby the impulsive voltage I is simultaneously applied to four rows, and 250 impulsive voltage application groups exist. In FIG. 8, the gate on voltage Von, the data voltages DV1-DV10, and the impulsive voltage I are applied in the same order as that in FIG. 3. However, the data voltage maintaining time DHT and the impulsive voltage maintaining time IHT differ from those in FIG. 3.

That is, after the gate on voltage Von is sequentially applied to first to fourth pixel rows at about 1H intervals such such that the data voltages DV1-DV4 are sequentially applied to the first to fourth pixel rows, the impulsive voltage I is simultaneously applied to four pixel rows that are the first to fourth pixel rows after about 500H including the application time of the data voltage DV4 with respect to the fourth pixel row.

Averages of the data voltage maintaining time DHT and the impulsive voltage maintaining time IHT in two adjacent frames are shown in FIG. 9.

As an example, referring to FIGS. 7 and 8, in the first pixel row, the data voltage maintaining times DHT are about 497H and about 503H, respectively, and the impulsive voltage maintaining times IHT are about 503H and about 497H, respectively. Thus, as shown in FIG. 9, the averages of the data voltage maintaining times DHT and the impulsive voltage maintaining times IHT are about 500H.

With respect to the second pixel to fourth pixle row, the averages of the data voltage maintaining time DHT and the impulsive voltage maintaining time IHT are about 500H, respectively.

Thereby, since the average of the data voltage maintaining time DHT and the impulsive voltage maintaining time IHT are equal in all pixel rows, a horizontal line error is prevented.

In FIG. 7, the gate on voltage Von is applied in a reverse order. Thereby, the application orders of the data voltages as well as the gate on voltage are reversed to FIGS. 3, 4, and 8.

For changing the application order of the data voltages, the signal controller 600 generates the output image signals DAT in the reverse order by image signal group unit to transmit to the data driver 500. In this embodiment, four output image signals are divided by one image signal group. In detail, a stream manager (not shown) of the signal controller 600 divides the input image signals R, G, and B by the the image signal group unit in the odd-numbered frames, and then outputs the output image signals DAT in the reverse order in the image signal group. However, the signal controller 600 sequentially outputs the output image signals DAT in even-numbered frames.

In addition, the gate driver 400 applies the gate on voltage Von to the fourth gate line to the first gate line in the respective line group unit of the odd-numbered frames such that the gate on voltage Von is applied in a reverse order in one gate line group, but sequentially applied the gate on voltage Von to the first gate line G1 to final gate line Gn. In similar to the image signal group, one gate line group has four gate lines.

When the LCD operates based on an operation frequency of about 120 Hz, the signal controller 600 outputs two output image signals with respect to one input image signal of about 60 Hz frequency. Thus, the signal controller 600 has a memory such as a frame memory such that two output image signals with respect to one input image signal are applied for two frames such as an odd-numbered frame and an even-numbered frame.

As described above, in this embodiment, the gate on voltage Von and the data voltages are applied in the reverse order in the image signal group and the gate line group in odd-numbered frames, respectively, but the gate on voltage Von and the data voltages are sequentially applied in even-numbered frames. Thereby, since the average of the data voltage maintaining time DHT and the impulsive voltage maintaining time IHT are substantially uniform in the odd-numbered frames and the even-numbered frames, the horizontal line error is prevented.

Even though the embodiments in FIGS. 7 and 8 are different from those in FIGS. 3 and 4, the embodiments in FIGS. 7 and 8 may be adapted with respect to the operation frequency of about 180 Hz like FIGS. 3 and 4.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a plurality of pixels arranged in a matrix;
data lines and gate lines coupled to the pixels;
a signal controller adapted to process received image data and generate normal image data and impulsive image data;
a gray voltage generator operative to generate a plurality of gray voltages; and
a data driver coupled to the gray voltage generator, the data driver being operative to select data voltages and an impulsive voltage corresponding to the normal image data and the impulsive image data from among the gray voltages, respectively, and apply the data voltages and impulsive voltage to the data lines,
wherein the data driver is operative to apply impulsive voltage simultaneously to impulsive voltage application units each comprising a plurality of pixel rows,
wherein the application is such that within one frame an impulsive voltage is applied to a plurality of impulsive voltage applications units, and further wherein
positions of first rows of the respective impulsive voltage application units of two adjacent frames in a unit frame group vary by a predetermined number of rows.

2. The liquid crystal display of claim 1, wherein the impulsive voltage application unit has N rows, where N is of a multiple of “2”.

3. The liquid crystal display of claim 2, wherein the unit frame group comprises two successive frames, and positions of the first rows of the corresponding impulsive voltage application of two adjacent frames of the unit frame group have a difference of N/2.

4. The liquid crystal display of claim 3, wherein the signal controller is operative to output about 120 frames per second to the data driver.

5. The liquid crystal display of claim 4, wherein a maintaining time of the data voltage and a maintaining time of the impulsive voltage between the adjacent pixel rows have a difference of about 1H, respectively.

6. The liquid crystal display of claim 1, further comprising a gate driver coupled to the gate lines, the gate driver being operative to apply a gate on voltage to the gate lines voltage twice for one frame.

7. A driving method of a liquid crystal display comprising a plurality of pixels arranged in a matrix, and a plurality of gate lines and a plurality of data lines that are connected to the pixels, the driving method comprising:
transmitting normal image data and impulsive image data by processing image data from an external device;
generating a plurality of gray voltages;
applying a gate on voltage twice to the gate lines;
selecting data voltages and an impulsive voltage corresponding to the normal image data and the impulsive image data among the gray voltages, respectively and applying to the data lines; and
applying the impulsive voltage simultaneously to impulse voltage application units each unit comprising a plurality of pixel rows,
wherein each frame has a plurality of impulsive application units and further wherein, to which the impulsive voltage is applied,
positions of first rows of the respective impulsive voltage application units of two adjacent frames are spaced apart by a predetermined number of rows.

8. The driving method of claim 7, wherein the impulsive voltage application unit has N rows, where N is a multiple of “2”.

9. The driving method of claim 8, wherein the unit frame group comprises two successive frames, and positions of the first rows of the corresponding impulsive voltage application groups of two adjacent frames of the unit frame group have a difference of N/2.

10. The driving method of claim 9, wherein the transmission of the normal image data and the impulsive image data comprises outputting about 120 frames per second.

11. The driving method of claim 10, wherein a maintaining time of the data voltage and a maintaining time of the impulsive voltage between the adjacent pixel rows have a difference of about 1H, respectively.

12. A liquid crystal display comprising:
a plurality of pixels arranged in a matrix;
data lines and gate lines coupled to the pixels;
a signal controller adapted to process received image data and generate normal image data and impulsive image data;
a gate driver adapted to apply a gate on voltage to the gate lines;
a gray voltage generator operative to generate a plurality of gray voltages; and
a data driver coupled to the gray voltage generator, the data driver being operative to select data voltages and an impulsive voltage corresponding to the normal image data and the impulsive image data from among the gray voltages, respectively, and apply the data voltages and impulsive voltage to the data lines,
wherein the data driver is operative to apply impulsive voltage simultaneously to impulsive voltage application units each comprising a plurality of pixel rows,
wherein the application is such that within one frame an impulsive voltage is applied to a plurality of impulsive voltage applications units, and further wherein gate on voltage application orders corresponding the data voltages in the impulsive voltage application units corresponding to each other in two adjacent frames of a unit frame group are opposite, respectively.

13. The liquid crystal display of claim 12, wherein the data voltages in the impulsive voltage application units are applied in a reverse order in accordance with the gate on voltage application order.

14. The liquid crystal display of claim 13, wherein the signal controller comprises a frame memory, and generates the normal image data in the reverse order in the impulsive voltage application units to apply the data voltages in the reverse order.

15. The liquid crystal display of claim 12, wherein the gate driver applies the gate on voltage twice to one gate line in a frame.

16. A driving method of a liquid crystal display comprising a plurality of pixels arranged in a matrix, and a plurality of gate lines and a plurality of data lines that are connected to the pixels, the driving method comprising:
transmitting normal image data and impulsive image data by processing image data from an external device;
generating a plurality of gray voltages;
applying a gate on voltage twice to the gate lines;
selecting data voltages and an impulsive voltage corresponding to the normal image data and the impulsive image data among the gray voltages, respectively and applying to the data lines; and
applying the impulsive voltage simultaneously to impulse voltage application units each unit comprising a plurality of pixel rows, wherein each frame has a plurality of impulsive application units, each to which the impulsive voltage is applied, and further wherein gate on voltage application orders corresponding the data voltages in the impulsive voltage application units corresponding to each other in two adjacent frames of a unit frame group are opposite, respectively.

17. The driving method of claim 16, wherein the selection of the data voltages and the impulsive voltage comprises applying the data voltages in the impulsive voltage application units in a reverse order in accordance with the gate on voltage application order when the gate on voltage is applied in the reverse order.

18. A liquid crystal display comprising:
a plurality of pixels arranged in a matrix;
data lines and gate lines coupled to the pixels;
a signal controller adapted to process received image data and to generate normal image data and impulsive image data;
a gate driver adapted to apply a gate on voltage to the gate lines;
a gray voltage generator operative to generate a plurality of gray voltages; and
a data driver coupled to the gray voltage generator, the data driver being operative to select data voltages and an impulsive voltage corresponding to the normal image data and the impulsive image data from among the gray voltages, respectively, and apply the data voltages and impulsive voltage to the data lines,
wherein a plurality of pixels arranged in respective rows respectively have a data holding time that the data voltages are sustained and a black holding time that the impulsive voltage is sustained during a frame, and
the data holding time and the black holding time are changed in at least 2 sequential frames such that an average of luminance of respective rows is substantially the same during the at least 2 sequential frames.

19. The liquid crystal display of claim 18, wherein the data driver is operative to apply impulsive voltage simultaneously to impulsive voltage application units each comprising a plurality of pixel rows,
wherein the application is such that within one frame an impulsive voltage is applied to a plurality of impulsive voltage applications units, and
further wherein positions of first rows of the respective impulsive voltage application units of two adjacent frames in a unit frame group vary by a predetermined number of rows.

20. The liquid crystal display of claim 18, wherein the data driver is operative to apply impulsive voltage simultaneously to impulsive voltage application units each comprising a plurality of pixel rows,
wherein the application is such that within one frame an impulsive voltage is applied to a plurality of impulsive voltage applications units, and
further wherein gate on voltage application orders corresponding to the data voltages in the impulsive voltage application units corresponding to each other in two adjacent frames of a unit frame group are opposite, respectively.

21. A driving method of a liquid crystal display comprising a plurality of pixels arranged in a matrix, and a plurality of gate lines and a plurality of data lines that are connected to the pixels, the driving method comprising:
transmitting normal image data and impulsive image data by processing image data from an external device;
generating a plurality of gray voltages;
applying a gate on voltage twice to the gate lines; and
selecting data voltages and an impulsive voltage corresponding to the normal image data and the impulsive image data among the gray voltages, respectively and applying to the data lines,
wherein a plurality of pixels arranged in respective rows respectively have a data holding time that the data voltages are sustained and a black holding time that the impulsive voltage is sustained during a frame, and
the selection of the data voltages and the impulsive voltage comprises changing the data holding time and the black holding time in at least 2 sequential frames such that a averaged of luminance of respective rows is substantially same during the at least 2 sequential frames.

22. The driving method of claim 21, wherein the selection of the data voltages and the impulsive voltage further comprises
applying the impulsive voltage simultaneously to impulse voltage application units each unit comprising a plurality of pixel rows,
wherein each frame has a plurality of impulsive application units and further wherein, to which the impulsive voltage is applied, and
positions of first rows of the respective impulsive voltage application units of two adjacent frames are spaced apart by a predetermined number of rows.

23. The driving method of claim 21, wherein the selection of the data voltages and the impulsive voltage further comprises
applying the impulsive voltage simultaneously to impulse voltage application units each unit comprising a plurality of pixel rows,
wherein each frame has a plurality of impulsive application units, each to which each impulsive voltage is applied, and
further wherein gate on voltage application orders corresponding to the data voltages in the impulsive voltage application units corresponding to each other in two adjacent frames of a unit frame group are opposite, respectively.
